(19) United States
(12) Patent Application Publication
(10) Pub. No.: US 2026/0323311 A1
(43) Pub. Date: Oct. 15, 2026

(54) A NETWORK CONTROL UNIT FOR COORDINATING AN INTERFERENCE MITIGATION SCHEME IN A MICROWAVE NETWORK

(71) Applicant: Telefonaktiebolaget LM Ericsson (publ), Stockholm (SE)

(72) Inventors: Magnus NILSSON, Kungsbacka (SE); Henrik SAHLIN, Mölnlycke (SE); Mikael COLDREY, Borås (SE); Rahul DEVASSY, Göteborg (SE); Lei BAO, Göteborg (SE); Per-Arne THORSÉN, Öjersjö (SE); Christoffer FOUGSTEDT, Torslanda (SE); Oskar TALCOTH, Göteborg (SE); Christian CZEGLEDI, Göteborg (SE)

(73) Assignee: Telefonaktiebolaget LM Ericsson (publ), Stockholm (SE)

(21) Appl. No.: 19/106,473

(22) PCT Filed: Aug. 30, 2022
(86) PCT No.: PCT/SE2022/050776

§ 371 Date: Feb. 25, 2025

(51) Int. Cl. H04W 24/02

(52) U.S. Cl. CPC H04W 24/02

(57) ABSTRACT

The present invention relates to a network control unit and method for coordinating an interference mitigation scheme in a microwave network. The network control unit is configured to assign and distribute preambles to the microwave communication nodes in the microwave network, such that each microwave communication node is associated with a preamble that allows other microwave communication nodes in the microwave network to identify the microwave communication node.

### TECHNICAL FIELD

The present invention relates to a network control unit and a method in a network control unit for coordinating an interference mitigation scheme in a microwave network.

### BACKGROUND

Data traffic in radio access networks is growing rapidly. The increase in traffic implies a densification of the radio access network using smaller cells. This densification will also impact the microwave backhaul network. At the same time, there is a trend of higher frequency reuse in microwave networks to save costs. Current microwave backhaul networks avoid interference by careful planning, but increased densification and higher frequency reuse will inevitably lead to much higher interference between radio links. Hence, future microwave networks will require new tools that allow for control and mitigation of interference.

Another problem is that existing power control methods combined with higher frequency reuse can lead to power rushes, which in turn will cause unnecessary interference in the network. By having better knowledge of interference levels in the microwave network, the transmit power of the links could be controlled in a smarter way.

There are currently no means for determining how different microwave communication nodes in the microwave backhaul network interfere with one another. Hence, to allow further densification of radio access networks, there is a need for effective interference detection and mitigation schemes in microwave backhaul networks.

### SUMMARY

It is an object of the present invention to remedy, or at least alleviate, some of these drawbacks and to provide a communication node that can detect and mitigate interference.

According to a first aspect, the invention describes a network control unit for coordinating an interference mitigation scheme in a microwave network. The network control unit is configured to assign preambles to the microwave communication nodes in the microwave network, such that each microwave communication node is associated with a preamble that allows other microwave communication nodes in the microwave network to identify said microwave communication node. The network control unit may be configured to distribute a codebook of preambles to a microwave communication node in the microwave network, wherein the codebook of preambles comprises the preambles of at least one of the other microwave communication nodes in the microwave network.

According to a second aspect, the invention describes a method in a network control unit for coordinating an interference mitigation scheme in a microwave network. The method comprising the step of assigning preambles to the microwave communication nodes in the microwave network, such that each microwave communication node is associated with a preamble that allows other microwave communication nodes in the microwave network to identify said microwave communication node. The method may further comprise the step of distributing a codebook of preambles to each microwave communication nodes in the microwave network, wherein the codebook of preambles comprises the preamble/preambles of at least one of the other microwave communication nodes in the microwave network.

By using the above network control unit, interference between microwave communication nodes can be both detected and mitigated. Hence, the above network control unit and method have the advantage of enabling increased frequency reuse and densification in microwave networks.

### BRIEF DESCRIPTION OF THE DRAWINGS

FIG. 1 shows schematically in a block a first example of a microwave backhaul network,

FIG. 2 shows schematically in a block a second example of a microwave backhaul network,

FIG. 3 shows schematically in a block a third example of a microwave backhaul network,

FIG. 4A shows schematically in a block diagram microwave communication node comprising a network control unit according to a first embodiment of the invention,

FIG. 4B shows schematically in a block diagram a microwave communication node and a network control unit according to a first embodiment of the invention,

FIG. 5A shows schematically in a flowchart a method according to a second embodiment of the invention,

FIG. 5B shows schematically in a flowchart a method according to a second embodiment of the invention, and

FIG. 6 shows schematically an example of a hardware implementation of the present invention.

The drawings are not necessarily to scale, and the dimensions of certain features may have been exaggerated for the sake of clarity. Emphasis is instead being placed upon illustrating the principle of the embodiments herein.

### DETAILED DESCRIPTION

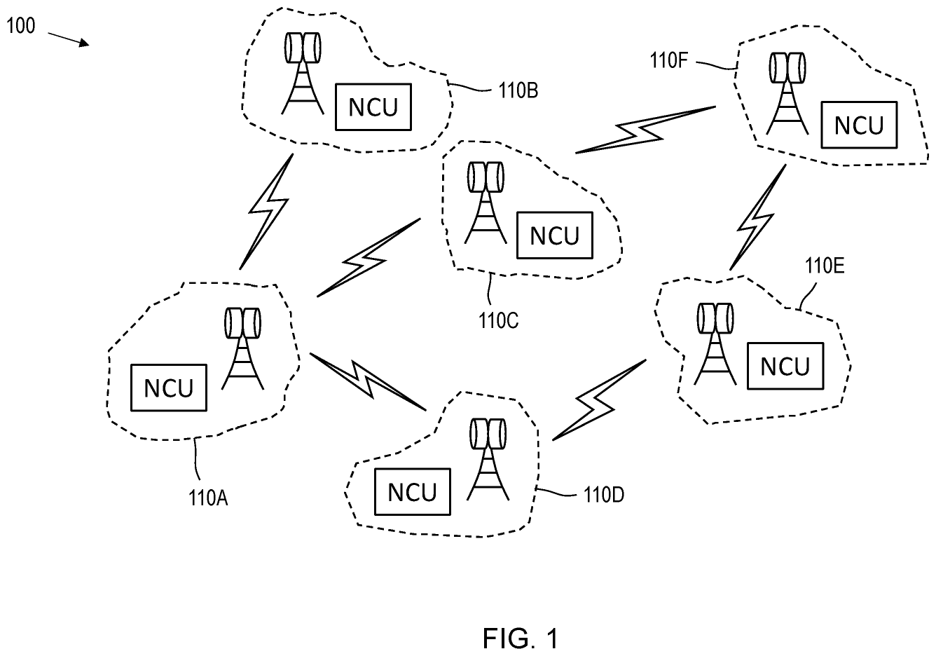

Two embodiments of the present invention and variants thereof are described in detail below with reference to FIGS. 1-6. A first embodiment of the invention relates to a network control unit. A second embodiment relates to a method in a network control unit. It should be noted that the scope of the present invention is not limited to the particular embodiments described herein, but only limited by the appended claims.

The following abbreviations are used in the text and the drawings:
NCU Network Control Unit
RX Receiver
SINR Signal-to-Interference-plus-Noise Ratio
TX Transmitter

In the following, features of the first embodiment and variants thereof are described with reference to FIGS. 1-5. The first embodiment relates to a network control unit for coordinating an interference mitigation scheme in a microwave network 100, 200, 300.

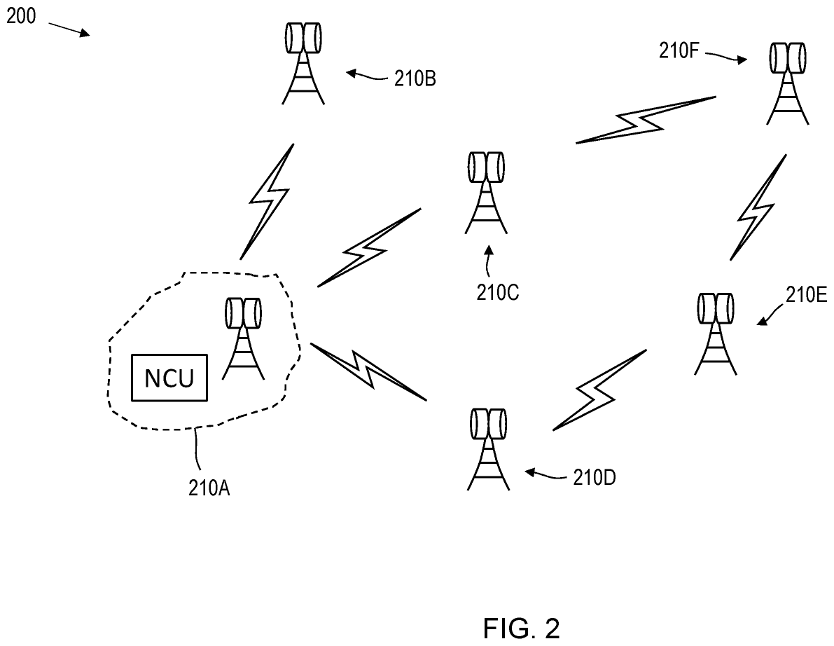

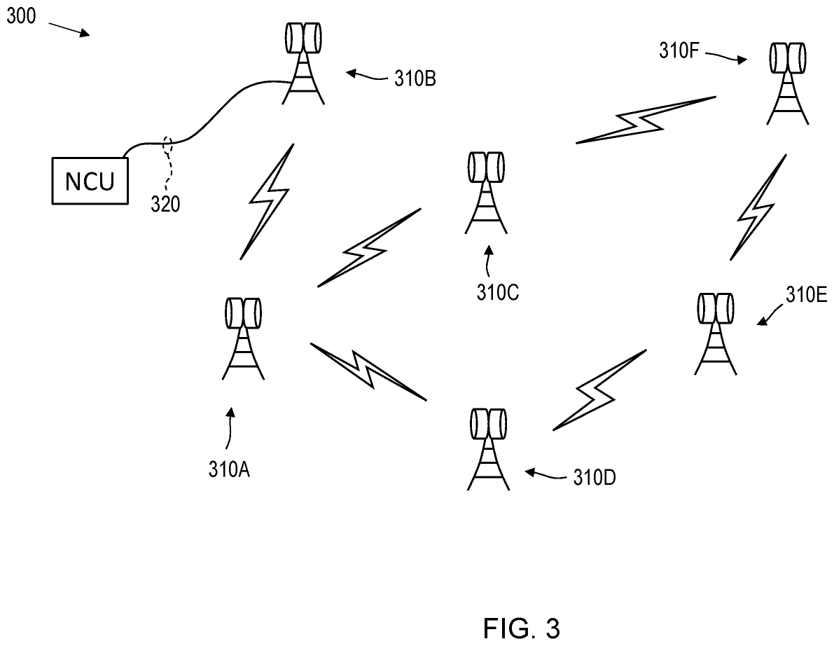

FIGS. 1-3 provide examples of microwave networks 100, 200, 300 comprising a plurality of microwave communication nodes 110A-F, 210A-F, 310A-F and one or more network control units. Each microwave communication node is arranged for communication with at least one other microwave communication node in the microwave network 100, 200, 300. FIG. 1 depicts a microwave network 100 where each microwave communication node in the network comprises its own network control unit. FIG. 2 depicts a microwave network 200 where a network control unit is comprised in one microwave communication node 210A that also serves other communication nodes 201B-F in the network. FIG. 3 depicts a microwave network 300 where the network control unit is a central unit. Here, the microwave communication nodes 310A-F do typically not comprise any network control unit, but at least one node has a connection 330, physically and/or wirelessly, to the central unit. A microwave communication node can thus always connect to the network control unit via other nodes in the network.

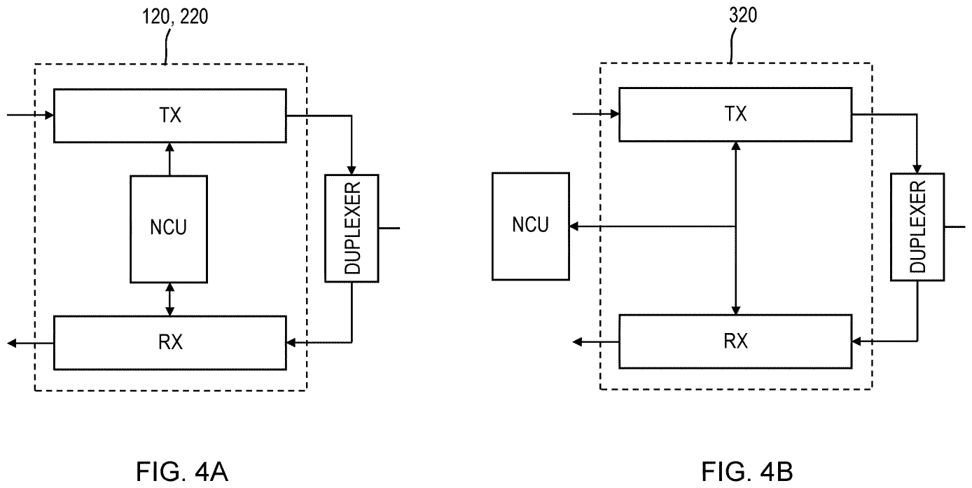

FIG. 4A depicts a block diagram of the microwave communication node 110, 210 comprising a transmitter, a receiver and a network control unit. FIG. 4B depicts a block diagram of the microwave communication node 310 comprising a transmitter and a receiver that are connected, physically and/or wirelessly, to a network control unit. The transmitter is configured to operate according to a set of transmit parameters, e.g. transmit power, antenna orientation and beamwidth. Likewise, the receiver is configured to operate according to a set of receive parameters, e.g. antenna orientation and beamwidth. The microwave communication nodes of FIGS. 4A and 4B may comprise additional transmitters and receivers if configured for communication with multiple other microwave communication nodes. An optional duplexer allows the transmitter and receiver to use the same antenna.

According to the first embodiment of the invention, the network control unit is configured to assign preambles to the microwave communication nodes 110A-F, 210A-F, 310A-F in the microwave network. The preambles are assigned such that each microwave communication node is associated with a preamble that allows other microwave communication nodes in the microwave network to identify said microwave communication node.

Each microwave communication node is configured to broadcast a preamble. The broadcasted preamble allows other microwave communication nodes in the network to identify the sender. The preamble is a sequence or code that typically is unique to the transmitter, however, the preamble may also be reused for other non-interfering transmitters, e.g. at a different geographical location. In one example, the preamble is a Zadoff-Chu sequence, an m-sequence, or a gold sequence. The preamble may be transmitted periodically or aperiodically, e.g. following a request by the network control unit.

The network control unit may further be configured to assign additional preamble codewords to at least one microwave communication node in the microwave network. Having multiple preamble codewords assigned to a transmitter allows the microwave communication node to encode information in the broadcasted preamble.

The network control unit may further be configured to distribute a codebook of preambles to a microwave communication node in the microwave network 100, 200, 300. The codebook of preambles comprises the preamble/preambles of at least one of the other microwave communication nodes in the microwave network.

The codebook may also comprise the preambles of all microwave communication nodes in the network. This may, however, not be optimal from a computational standpoint if the size of the codebook is too big. To manage the size of the codebook, the codebook of preambles may be confined to a subset of the preambles of all the microwave communication nodes in the microwave network. Preferably, the codebook should only comprise the preambles of microwave communication nodes that may interfere with the communication node. In one example, the subset consists of all microwave communication nodes within a predefined distance from a target microwave communication node.

The network control unit may further be configured to receive interference levels from at least one microwave communication node in a microwave network. Preferably, the network control unit receives interference levels from all nodes in the network.

The network control unit may also be configured to determine updated transmit-receive parameters for at least one microwave communication node in the microwave network 100, 200, 300 when an interference level exceeds a threshold value. Here, the threshold value represents an interference level that is considered too high for reliable communication. In one example, the threshold value is a SINR value. The threshold value may depend on channel conditions, capacity demands, traffic requirements or any other conditions that affect the communication link.

The updated transmit-receive parameters may be any transmit parameter, receive parameter or other measure that will reduce the interference level. The updated transmit-receive parameters correspond to a measure that aims to reduce the interference level that exceeds the threshold value. For example, the updated transmit-receive parameters may comprise reducing transmit power, narrowing beamwidth, and/or adjusting antenna orientation. In one example, the updated transmit-receive parameters from the network control unit comprise power related adjustment, such as reduced transmit power. In another example, the updated transmit-receive parameters from the network control unit comprise carrier related adjustment, such as carrier allocation and carrier bandwidth. In yet another example, the updated transmit-receive parameters from the network control unit comprise antenna adjustments, such as antenna orientation and/or beamforming.

The network control unit may further be configured to forward the updated transmit-receive parameters to the at least one microwave communication node. In one example, this is achieved by using the radio links of the microwave network to pass the updated transmit-receive parameters to a target microwave communication node. In another example, this is achieved by encoding the updated transmit-receive parameters in the preambles that are broadcasted by the microwave communication nodes.

In the following, features of the second embodiment and variants thereof are described with reference to FIGS. 1-5. The second embodiment relates to a network control unit for coordinating an interference mitigation scheme in a microwave network 100, 200, 300.

FIGS. 1-3 provide examples of microwave networks 100, 200, 300 comprising a plurality of microwave communication nodes 110A-F, 210A-F, 310A-F and one or more network control units. Each microwave communication node is arranged for communication with at least one other microwave communication node in the microwave network 100, 200, 300. FIG. 1 depicts a microwave network 100 where each microwave communication node comprises a network control unit. FIG. 2 depicts a microwave network 200 where a network control unit is comprised in one microwave communication node 210A and serves the communication nodes 201B-F in the network. FIG. 3 depicts a microwave network 300 where the network control unit is a central unit. Here, the microwave communication nodes 310A-F do typically not comprise any network control unit, but at least one node has a connection 330, physically and/or wirelessly, to the central unit. A microwave communication node can thus always connect to the network control unit via other nodes in the network.

FIG. 4A depicts a block diagram of the microwave communication node 110, 210 comprising a transmitter, a receiver and a network control unit. FIG. 4B depicts a block diagram of the microwave communication node 310 comprising a transmitter and a receiver that are connected, physically and/or wirelessly, to a network control unit. The transmitter is configured to operate according to a set of transmit parameters, e.g. transmit power, antenna orientation and beamwidth. Likewise, the receiver is configured to operate according to a set of receive parameters, e.g. antenna orientation and beamwidth. The microwave communication nodes of FIGS. 4A and 4B may comprise additional transmitters and receivers if configured for communication with multiple other microwave communication nodes. An optional duplexer allows the transmitter and receiver to use the same antenna.

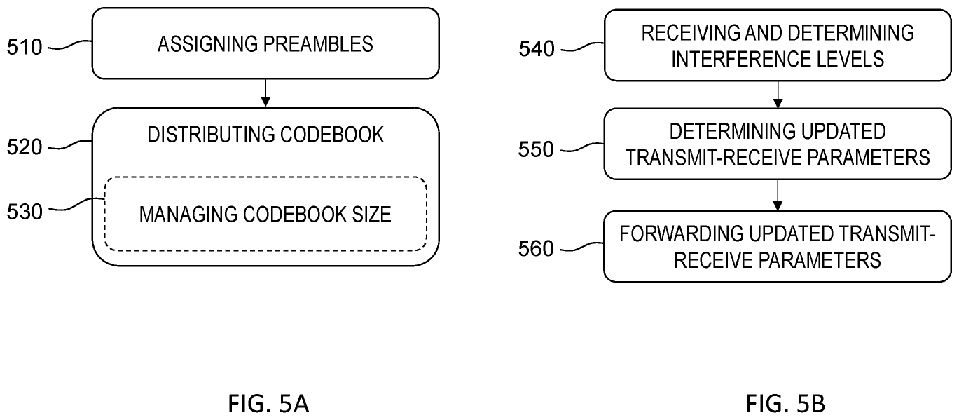

FIG. 5A depicts the steps of assigning 510, distributing 520 and managing 530.

The method performs the step of assigning 510 preambles to the microwave communication nodes 110A-F, 210A-F, 310A-F in the microwave network 100, 200, 300. The assigning 510 is performed such that each microwave communication node is associated with a preamble that allows other microwave communication nodes in the microwave network to identify said microwave communication node. The step of assigning 510 may further comprise assigning additional preambles to at least one microwave communication node in the microwave network. Having multiple preamble codewords assigned to a transmitter will allow information to be encoded in the broadcasted preamble.

The method may also comprise the step of distributing 520 a codebook of preambles to each microwave communication nodes in the microwave network 100, 200, 300. The codebook of preambles comprises the preamble/preambles of at least one of the other microwave communication nodes in the microwave network 100, 200, 300.

The codebook may comprise the preambles of all microwave communication nodes in the network. This may, however, not be optimal from a computational standpoint if the size of the codebook is too big. The step of distributing 520 may therefore further comprise the step of managing 530 the codebook size. For example, the codebook of preambles may be confined to a subset of the preambles of all the microwave communication nodes in the microwave network. Preferably, the codebook should only comprise the preambles of microwave communication nodes that may interfere with the communication node. In one example, the subset consists of all microwave communication nodes within a predefined distance from a target microwave communication node.

FIG. 5B depicts the steps of receiving 540, determining 550 and forwarding 540.

The method may further comprise the step of receiving 540 interference levels from at least one microwave communication node in the microwave network 100, 200, 300. The method may further comprise the step of determining 550 updated transmit-receive parameters for at least one microwave communication node in the microwave network 100, 200, 300 when an interference level exceeds a threshold value. Here, the threshold value represents an interference level that is considered too high for reliable communication. In one example, the threshold value is a SINR value. The threshold value may depend on channel conditions, capacity demands, traffic requirements or any other conditions that affect the communication link.

The updated transmit-receive parameters may be any transmit parameter, receive parameter or other measure that will reduce the interference level.

The updated transmit-receive parameters correspond to a measure that aims to reduce the interference level that exceeds the threshold value. For example, the updated transmit-receive parameters may comprise reducing transmit power, narrowing beamwidth, and/or adjusting antenna orientation. In one example, the updated transmit-receive parameters from the network control unit comprise power related adjustment, such as reduced transmit power. In another example, the updated transmit-receive parameters from the network control unit comprise carrier related adjustment, such as carrier allocation and carrier bandwidth. In yet another example, the updated transmit-receive parameters from the network control unit comprise antenna adjustments, such as antenna orientation and/or beamforming.

The method may further comprise the step of forwarding 560 the updated transmit-receive parameters to the at least one microwave communication node. In one example, this is achieved by using the radio links of the microwave network to pass the updated transmit-receive parameters to a target microwave communication node. In another example, this is achieved by encoding the updated transmit-receive parameters in the preambles that are broadcasted by the microwave communication nodes.

In the following, some alternative aspects and variations on the above discussed embodiments are provided.

In one example, different preambles are assigned to different links. Each link knows the preambles of its neighbouring links.

In one example, the preamble is configured by a central unit, e.g. as operations, administration and management. The central unit is responsible for distributing a preamble list to the nodes in the network.

In one example, the encoded information in the preamble comprises at least one of link location, carrier frequency and transmission direction.

In one example, silent periods can be used as a special case of preamble with zero transmit power. This requires synchronization of the nodes.

In one example, the preamble is selected based on if a node experiences high interference level or not. Two sets of preambles are then predefined, one to be used for nodes which experience low interference and one set of preambles to be used by nodes which experience high interference levels. If a node detects a preamble belonging to the set of high interference nodes, then it can take actions to reduce interference for other nodes.

In one example, the two directional links in one microwave hop are assigned with different preambles. In a related embodiment, the two directional links in one microwave hop can share the same preamble.

In one example, the preamble list is updated and redistributed when new links are deployed in the system.

In one example, the preamble list is updated and redistributed when links are removed from the system.

In one example, identical preambles can be used by several microwave hops in the same backhaul network provided that the hops are sufficiently separated.

In one example, the detection algorithm detects the preambles of neighbouring links and calculates its amount of interference.

In one example, all the links are synchronized such that they can transmit their preambles at the same time.

In one example, the transmission and measurement of the preambles are coordinated. The coordination may avoid situations when two links which should perform mutual measurements go silent at the same time.

In one example, the interference level can be determined based on, but not limited to, RSSI (Received Signal Strength Indicator), SINR (Signal-to-Interference-Noise Ratio), MSE (Mean Squared Error), RSRP (Reference Signal Received Power), RSRQ (Reference Signal Received Quality). The reference signal is referred to the preamble.

In one example, interference level can be calculated by using the preamble to first calculate the interference channel. The interference level is then given by the interference channel and transmitted power of the interfering link.

In one example, the measurement report is sent to the central unit.

In one example, the measurement report is sent to the interfering node directly or via central unit. Direct transmissions between nodes can be either over air or wired.

In one example, the node does not report its measurements but instead make node internal actions to reduce interference such as changing transmission power and beam steering.

In one example, the interference mitigation is controlled by the central unit, e.g. the central unit makes the decision and informs the interfering and victim units.

In one example, the interference mitigation is performed without centralized control, e.g., the interfering unit informs the victim unit about interference situation.

In one example, the victim unit cannot mandate the interfering unit to change the transmission configuration.

In one example, the interfering unit may signal ACK/NACK message to the victim unit about the change of the transmission configuration.

In one example, transmission configuration can be configuring transmit powers of the links.

In one example, transmission configuration can be configuring frequency channels for bi-directional traffic over the links (“UL/DL”).

In one example, transmission configuration can be configuring both transmit power and frequency channels.

In one example, the input to the central node can be system and deployment parameters of one microwave hop such as antenna type, link position and network topology.

In one example, the input to the central node can be capacity and traffic requirement related parameters such as QoS, capacity demand and available bandwidth.

In one example, the input to the central node can be operational conditions such as pathloss, propagation channel conditions, interference levels and buffer status.

In one example, the decision from the central node can be power related adjustment, such as transmit power.

In one example, the decision from the central node can be data rate adjustment, such as modulation and coding.

In one example, the decision from the central node can be carrier related adjustment, such as carrier allocation and carrier bandwidth.

In one example, the decision from the central node can be antenna adjustment, such as antenna tilt, beam direction and beamforming.

In one example, the decision from the central node can be prioritization of the traffic data.

In one example, the decision from the central node can be a coordination of the reference signalling, including configuration of the reference signal at the aggressor node, e.g. reference signal preambles, and configuration of interference measurement at the victim node, e.g. the set of preambles to measure.

In one example, the communication between the central node and the microwave link can be wired or wireless connection.

In one example, the communication between the central node and a microwave link can be via one or several intermediate nodes.

In one example, two, or more, central nodes exchange information.

In one example, the central nodes can prioritize backhaul between nodes. One example is mission critical communications, e.g. first responders such as firefighters and ambulance. Other examples are to prioritize voice and online video over low priority data traffic.

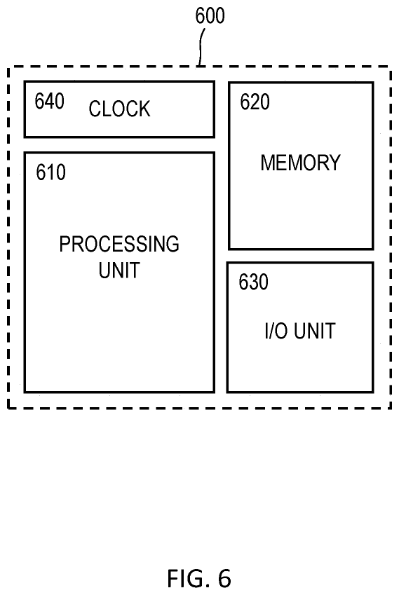

According to yet another aspect of the invention, the network control unit may be implemented as a processing unit 610, a memory 620, an input/output unit 630 and a clock 640 as is illustrated in FIG. 6. The processing unit 610, the memory 620, the I/O unit 630 and the clock 640 may be interconnected. The processing unit 610 may comprise a central processing unit, a digital signal processor, a multiprocessor system, programmable logic, a field programmable gate array (FPGA) or an application specific integrated circuit (ASIC) or any other type of logic. The memory 620 may comprise random access memory (RAM), read only memory (ROM) or any other type of volatile or non-volatile memory. The I/O unit 630 may comprise circuitry for controlling and performing signal conversions on I/O data. The I/O unit 630 may further comprise a transceiver.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

1. A network control unit (NCU) for coordinating an interference mitigation scheme in a microwave network, characterized in that:
the network control unit (NCU) is configured to assign preambles to the microwave communication nodes in the microwave network, such that each microwave communication node is associated with a preamble that allows other microwave communication nodes in the microwave network to identify said microwave communication node.

2. The network control unit according to claim 1, wherein:
the network control unit (NCU) is further configured to assign additional preamble codewords to at least one microwave communication node in the microwave network.

3. The network control unit (NCU) according to claim 1, wherein
the network control unit (NCU) is further configured to distribute a codebook of preambles to a microwave communication node in the microwave network, wherein the codebook of preambles comprises the preamble/preambles of at least one of the other microwave communication nodes in the microwave network.

4. The network control unit (NCU) according to claim 3, wherein the codebook of preambles is a subset of all the preambles of the other microwave communication nodes in the microwave network.

5. The network control unit (NCU) according to claim 4, wherein the subset consists of all other microwave communication nodes within a predefined distance from the microwave communication node.

6. The network control unit (NCU) according to claim 1, wherein:
the network control unit (NCU) is configured to receive interference levels from at least one microwave communication node in a microwave network, and
the network control unit (NCU) is configured to determine updated transmit-receive parameters for at least one microwave communication node in the microwave network when an interference level exceeds a threshold value, wherein the updated transmit-receive parameters correspond to a measure that will reduce the interference level that exceeds the threshold value, and
the network control unit (NCU) is configured to forward the updated transmit-receive parameters to the at least one microwave communication node.

7. The network control unit according to claim 6, wherein the updated transmit-receive parameters comprise reducing transmit power.

8. The network control unit according to claim 4, wherein the threshold value depends on at least capacity demand and channel conditions.

9. A method in a network control unit (NCU) for coordinating an interference mitigation scheme in a microwave network, the method comprising the step of:
assigning preambles to the microwave communication nodes in the microwave network, such that each microwave communication node is associated with a preamble that allows other microwave communication nodes in the microwave network to identify said microwave communication node.

10. The method according to claim 9, wherein the step of assigning further comprises assigning additional preambles to at least one microwave communication node in the microwave network.

11. The method according to claim 9, wherein the method further comprising the step of:
distributing a codebook of preambles to each microwave communication nodes in the microwave network, wherein the codebook of preambles comprises the preamble/preambles of at least one of the other microwave communication nodes in the microwave network.

12. The method according to claim 11, wherein the step of distributing further comprises the step of:
managing the codebook size such that the codebook of preambles is a subset of all the preambles of the other microwave communication nodes in the microwave network.

13. The method according to claim 12, wherein the subset consists of the preambles of other microwave communication nodes within a predefined distance from the microwave communication node.

14. The method according to claim 9 wherein the method further comprises the steps of:
receiving interference levels from at least one microwave communication node in a microwave network, and
determining updated transmit-receive parameters for at least one microwave communication node in the microwave network when an interference level exceeds a threshold value, wherein the updated transmit-receive parameters correspond to a measure that will reduce the interference level that exceeds the threshold value, and
forwarding the updated transmit-receive parameters to the at least one microwave communication node.

15. The method according to claim 14, wherein the updated transmit-receive parameters comprise reducing transmit power.

16. The method according to claim 14, wherein the threshold value depends on at least capacity demand and channel conditions.
